(19) United States
(12) Patent Application Publication
(10) Pub. No.: US 2016/0299987 A1
(43) Pub. Date: Oct. 13, 2016

(54) CROWD SOURCED F-PATTERN UTILIZATION FOR WEB PAGE COMPONENT PLACEMENT OPTIMIZATION

(71) Applicant: International Business Machines Corporation, Armonk, NY (US)

(72) Inventors: Judith H. Bank, Cary, NC (US); Liam Harpur, Dublin (IE); Patrick O'Sullivan, Dublin (IE); Lin Sun, Morrisville, NC (US)

(21) Appl. No.: 14/683,271

(22) Filed: Apr. 10, 2015

(51) Int. Cl. G06F 17/30; H04L 29/08

(52) U.S. Cl. CPC G06F 17/30893; H04L 67/02

(57) ABSTRACT

Embodiments of the invention provide a method, system and computer program product for crowd-sourced F-pattern utilization in Web page component optimization. In an embodiment of the invention, a method for crowd-sourced F-pattern utilization in Web page component optimization includes serving copies of a Web page to different viewers over a computer communications network and receiving data in respect to viewing patterns of the different viewers of the copies of the Web page. From the data received from the different viewers, a crowd-sourced F-pattern for the Web page is computed. Subsequent to serving the copies of the Web page, placement of components of the Web page is modified to place more important components within the crowd-sourced F-pattern to the exclusion of other components of the Web page. Finally, copies of the Web page as modified are served to subsequent requesting viewers over the computer communications network.

### BACKGROUND OF THE INVENTION

1. Field of the Invention

The present invention relates to optimized placement of Web page components and more particularly to optimized placement of Web page components utilizing gaze tracking of a viewer of the Web page.

2. Description of the Related Art

A Web page in its most simplistic form is a collection of text and sometimes images, arranged so as to present the collection to one or more requesting viewers from over a computer communications network. Simple Web pages of limited content require little in the form of the strategic placement of the components of the Web page. However, more densely populated, complex collections in a Web page present a different problem. In this instance, absent the strategic placement of Web site components in a Web page, much of the content of the Web page may go unrecognized by its intended audience.

Eye movement is a tool frequently utilized in the strategic placement of Web site components. Gaze tracking in particular has been an important element in heat mapping Web pages so as to identify those portions of the Web page to which human attention is paid, and those portions of the Web page to which human attention is not paid. With the data gleaned from gaze tracking, Web page components can be dynamically reorganized to adapt the Web page to the eye movements of the end user. Alternatively, portions of a Web page determined to be ignored can be decorated so as to dynamically draw the attention of the end user to the desired, but ignored portion of the Web page.

Of note, an analysis of heat maps oftentimes can result in the recognition of F-patterns. F-patterns appear in most non-landing Web pages. By tracking the gaze of the eye of a test subject, it has been recognized that Web page viewers naturally focus on a point in the upper left corner of the Web page, skim to the right, look down, skim to the right again, and so forth, until an “F” shape region has been mapped. The F-pattern occurs because the user typically scans horizontally less and less as the eyes of the viewer moves downwards.

### BRIEF SUMMARY OF THE INVENTION

Embodiments of the present invention address deficiencies of the art in respect to Web page component placement optimization and provide a novel and non-obvious method, system and computer program product for crowd-sourced F-pattern utilization in Web page component optimization. In an embodiment of the invention, a method for crowd-sourced F-pattern utilization in Web page component optimization includes serving copies of a Web page to different viewers over a computer communications network and receiving data in respect to viewing patterns of the different viewers of the copies of the Web page. From the data received from the different viewers, a crowd-sourced F-pattern for the Web page is computed. Subsequent to serving the copies of the Web page, placement of components of the Web page is modified to place more important components within the crowd-sourced F-pattern to the exclusion of other components of the Web page. Optionally, the components are rated in terms of importance and more highly rated ones of the components are placed in the crowd-sourced F-pattern of the modified Web page. Finally, copies of the Web page as modified are served to subsequent requesting viewers over the computer communications network.

In one aspect of the embodiment, multiple different crowd-sourced F-patterns are computed each for corresponding ones of the different viewers with a common viewing profile. Thereafter, the Web page is modified differently for each different crowd-sourced F-pattern. Finally, copies of each different modified Web page modified by a corresponding one of the different crowd-sourced F-patterns are served to corresponding viewers with a viewing profile common to the corresponding one of the different crowd-sourced F-patterns.

In another aspect of the embodiment, multiple different crowd-sourced F-patterns are computed each for corresponding ones of the different viewers with common device display dimensions. Thereafter, the Web page is modified differently for each different crowd-sourced F-pattern. Finally, copies of each different modified Web page modified by a corresponding one of the different crowd-sourced F-patterns are served to corresponding viewers with device display dimensions common to the corresponding one of the different crowd-sourced F-patterns.

In even yet another aspect of the embodiment, multiple different crowd-sourced F-patterns are computed each for corresponding ones of the different viewers of a common social network. Thereafter, the Web page is modified differently for each different crowd-sourced F-pattern. Finally, copies of each different modified Web page modified by a corresponding one of the different crowd-sourced F-patterns are served to corresponding viewers of a social network common to the corresponding one of the different crowd-sourced F-patterns.

In another embodiment of the invention, a Web page component optimization data processing system us configured for crowd-sourced F-pattern utilization. The system includes a host computing system that includes at least one computer with memory and at least one processor. The system also includes a Web server executing in the memory of the host computing system. Finally, the system includes a crowd-sourced F-pattern utilization module coupled to the Web server. The module includes program code enabled upon execution by at least one processor of the host computing system to serve copies of a Web page to different viewers over a computer communications network, to receive data in respect to viewing patterns of the different viewers of the copies of the Web page, to compute from the data received from the different viewers a crowd-sourced F-pattern for the Web page, to modify, subsequent to serving the copies of the Web page, placement of components of the Web page to place more important components within the crowd-sourced F-pattern to the exclusion of other components of the Web page, and to serve copies of the Web page as modified to subsequent requesting viewers over the computer communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for crowd-sourced F-pattern utilization in Web page component optimization;

FIG. 2 is a schematic illustration of a Web page component optimization data processing system configured for crowd-sourced F-pattern utilization; and,

FIG. 3 is a flow chart illustrating a process for crowd-sourced F-pattern utilization in Web page component optimization.

### DETAILED DESCRIPTION OF THE INVENTION

Embodiments of the invention provide for crowd-sourced F-pattern utilization in Web page component optimization. In accordance with an embodiment of the invention, eye tracking can be employed on a multiplicity of different viewers of a Web page so as to identify different viewing patterns for the different viewers of the same Web page. Thereafter, an F-pattern can be derived from the different viewing patterns so as to produce a crowd-sourced F-pattern. The crowd-sourced F-pattern then is used to dynamically re-organize components of the Web page for delivery to subsequent requesting viewers. Importantly, the crowd-sourced F-pattern can be continuously revised in accordance with the continuous acquisition of viewing patterns of different viewers of the Web page.

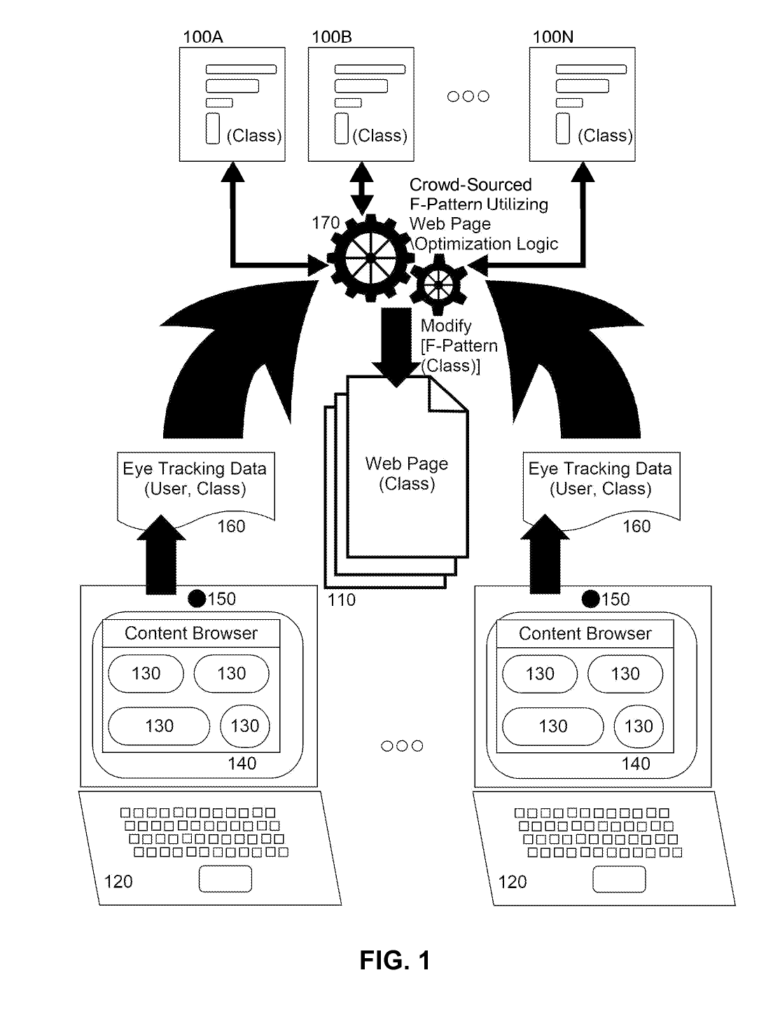

In further illustration, FIG. 1 pictorially shows a process for crowd-sourced F-pattern utilization in Web page component optimization. As shown in FIG. 1, different Web pages 110 can be provided for different classes of viewers, for instance viewers of different viewing characteristics, different end user roles, viewers belonging to different social networks, or viewers associated with different displays of different dimensions. Relevant copies of the different Web pages 110 can be served to the different viewers in accordance with a known class of the different viewers for viewing in respectively different content browsers 140 displayed in correspondingly different displays of different computers 120.

Of note, eye tracking can be performed upon each of the viewers utilizing cameras 150 embedded in each of the different computers 120 so as to identify a pattern of focus by each of the viewers upon the different components 130 of each of the copies of the Web pages 110. Resultant eye tracking data 160 can be returned to crowd-sourced F-Pattern utilizing Web page optimization logic 170 and associated with a class of user and the identity of the user. The logic 170 in turn can aggregate the eye tracking data 160 so as to produce different F-patterns 100A, 100B, 100N for different classes corresponding to the eye tracking data 160 utilized to generate the F-patterns 100A, 100B, 100N.

Thereafter, each of the Web pages 100 for each class can be modified in accordance with a corresponding one of the F-patterns 100A, 100B, 100N of a same class so as to re-arrange more important components therein to be within the corresponding one of the F-patterns 100A, 100B, 100N while less important components are excluded from the corresponding one of the F-patterns 100A, 100B, 100N. Finally, the relevant copies of the now modified, different Web pages 110 can be served to the different viewers in accordance with a known class of the different viewers for viewing in respectively different content browsers 140 displayed in correspondingly different displays of different computers 120. In this way, the copies of the Web pages 110 can be continuously optimized not only based upon the eye tracking of the viewers of the copies of the Web pages 110, but also in a personalized way based upon the class of the viewers.

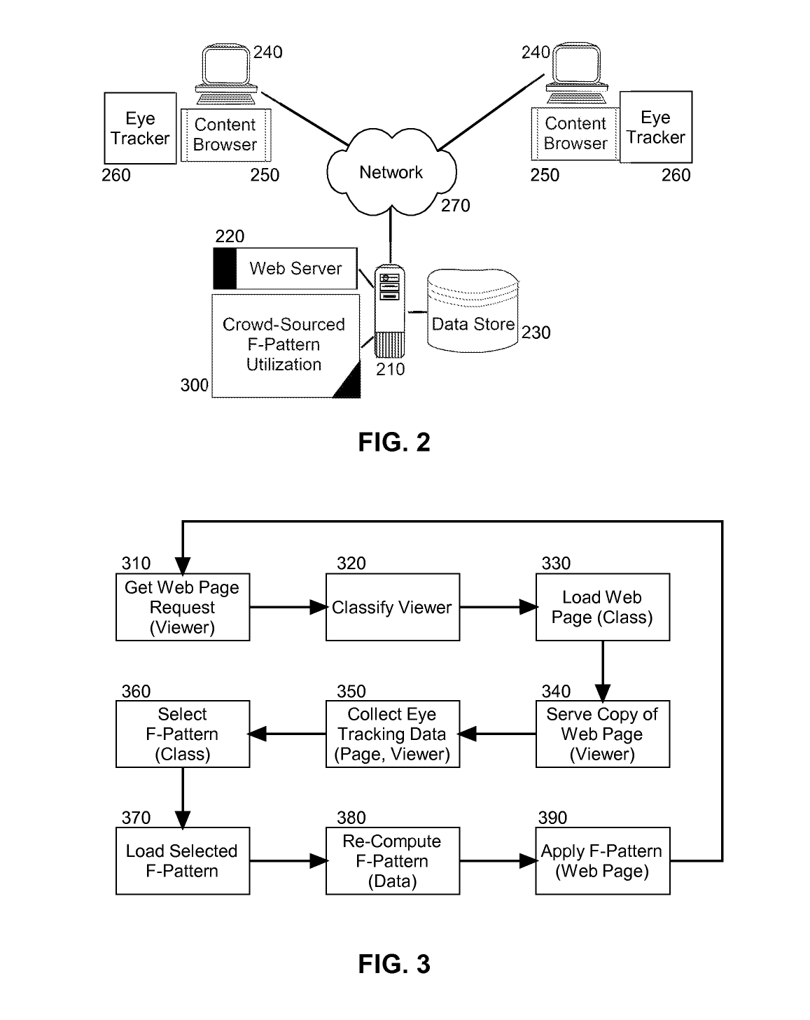

The process described in connection with FIG. 1 can be implemented in a Web page component optimization data processing system. In yet further illustration, FIG. 2 schematic illustrates a Web page component optimization data processing system configured for crowd-sourced F-pattern utilization. The system includes a host computing system 210 that includes one or more computers, each with memory and at least one processor. The host computing system 210 supports the operation of a Web server 220 configured to serve different copies of a Web page in a data store 230 to different viewers over computer communications network 270. In this regard, the different viewers may view the copies of the served Web pages in respectively different content browsers 250 of different client computing devices 240.

Of note, a crowd-sourced F-pattern utilization module 300 can be coupled to the Web server 220. The module 300 includes program code enabled upon execution in the memory of the host computing system 210 to receive eye-tracking data from different eye trackers 260 in the different client computing devices 240. The program code of the crowd-sourced F-pattern utilization module 300 additionally is enabled to generate an F-pattern from a composition of the eye tracking data from the different eye trackers 260 and to apply the generated F-pattern to the Web page by adjusting a positioning of different components of the Web page with respect to the generated F-pattern and a perceived importance of each of the different components. Finally, the program code of the crowd-sourced F-pattern utilization module 300 is enabled to continuously update the F-pattern with new eye-tracking data received from the eye trackers 260 and to continuously modify the Web page accordingly.

In even yet further illustration of the operation of the crowd-sourced F-pattern utilization module 300, FIG. 3 is a flow chart illustrating a process for crowd-sourced F-pattern utilization in Web page component optimization. Beginning in block 310, a request can be received from a viewer to retrieve a copy of a Web page. In block 320, the viewer can be classified, for instance, in terms of a characteristic pattern of viewing Web pages by the viewer, in terms of a role of the viewer, a membership by the viewer in a particular social network, or display characteristics of a display used by the viewer to view the Web pages. Thereafter, in block 330 a Web page associated with the class of the viewer can be retrieved for service to the viewer and in block 340, a copy of the retrieved Web page can be served to the viewer.

In block 350, eye-tracking data for the viewer viewing the copy of the Web page can be collected and in block 360, an F-pattern defined for the class of the viewer, selected for modification. In block 370, the selected F-pattern can be loaded into memory and in block 380, the F-pattern can be recomputed so as to account for the collected eye-tracking data. Finally, in block 390 the recomputed F-pattern can be applied to the Web page and the process can return to block 310 so as to effectuate a continuous updating of the F-pattern and corresponding Web page with newly collected eye-tracking data collected for the different viewers of the same class.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for crowd-sourced F-pattern utilization in Web page component optimization, the method comprising:
serving copies of a Web page to different viewers over a computer communications network;
receiving data in respect to viewing patterns of the different viewers of the copies of the Web page;
computing from the data received from the different viewers a crowd-sourced F-pattern for the Web page;
subsequent to serving the copies of the Web page, modifying placement of components of the Web page to place more important components within the crowd-sourced F-pattern to the exclusion of other components of the Web page; and,
serving copies of the Web page as modified to subsequent requesting viewers over the computer communications network.

2. The method of claim 1, wherein, multiple different crowd-sourced F-patterns are computed each for corresponding ones of the different viewers with a common viewing profile and the Web page is modified differently for each different crowd-sourced F-pattern and copies of each different modified Web page modified by a corresponding one of the different crowd-sourced F-patterns are served to corresponding viewers with a viewing profile common to the corresponding one of the different crowd-sourced F-patterns.

3. The method of claim 1, wherein, multiple different crowd-sourced F-patterns are computed each for corresponding ones of the different viewers with common device display dimensions and the Web page is modified differently for each different crowd-sourced F-pattern and copies of each different modified Web page modified by a corresponding one of the different crowd-sourced F-patterns are served to corresponding viewers with device display dimensions common to the corresponding one of the different crowd-sourced F-patterns.

4. The method of claim 1, wherein, multiple different crowd-sourced F-patterns are computed each for corresponding ones of the different viewers of a common social network and the Web page is modified differently for each different crowd-sourced F-pattern and copies of each different modified Web page modified by a corresponding one of the different crowd-sourced F-patterns are served to corresponding viewers of a social network common to the corresponding one of the different crowd-sourced F-patterns.

5. The method of claim 1, wherein the components are rated in terms of importance and more highly rated ones of the components are placed in the crowd-sourced F-pattern of the modified Web page.

6. A Web page component optimization data processing system configured for crowd-sourced F-pattern utilization, the system comprising:
a host computing system comprising at least one computer with memory and at least one processor;
a Web server executing in the memory of the host computing system; and,
a crowd-sourced F-pattern utilization module coupled to the Web server, the module comprising program code enabled upon execution by at least one processor of the host computing system to serve copies of a Web page to different viewers over a computer communications network, to receive data in respect to viewing patterns of the different viewers of the copies of the Web page, to compute from the data received from the different viewers a crowd-sourced F-pattern for the Web page, to modify, subsequent to serving the copies of the Web page, placement of components of the Web page to place more important components within the crowd-sourced F-pattern to the exclusion of other components of the Web page, and to serve copies of the Web page as modified to subsequent requesting viewers over the computer communications network.

7. The system of claim 6, wherein, multiple different crowd-sourced F-patterns are computed each for corresponding ones of the different viewers with a common viewing profile and the Web page is modified differently for each different crowd-sourced F-pattern and copies of each different modified Web page modified by a corresponding one of the different crowd-sourced F-patterns are served to corresponding viewers with a viewing profile common to the corresponding one of the different crowd-sourced F-patterns.

8. The system of claim 6, wherein, multiple different crowd-sourced F-patterns are computed each for corresponding ones of the different viewers with common device display dimensions and the Web page is modified differently for each different crowd-sourced F-pattern and copies of each different modified Web page modified by a corresponding one of the different crowd-sourced F-patterns are served to corresponding viewers with device display dimensions common to the corresponding one of the different crowd-sourced F-patterns.

9. The system of claim 6, wherein, multiple different crowd-sourced F-patterns are computed each for corresponding ones of the different viewers of a common social network and the Web page is modified differently for each different crowd-sourced F-pattern and copies of each different modified Web page modified by a corresponding one of the different crowd-sourced F-patterns are served to corresponding viewers of a social network common to the corresponding one of the different crowd-sourced F-patterns.

10. The system of claim 6, wherein the components are rated in terms of importance and more highly rated ones of the components are placed in the crowd-sourced F-pattern of the modified Web page.

11. A computer program product for crowd-sourced F-pattern utilization in Web page component optimization, the computer program product comprising a computer readable storage medium having program instructions embodied therewith, the program instructions executable by a device to cause the device to perform a method comprising:
serving copies of a Web page to different viewers over a computer communications network;
receiving data in respect to viewing patterns of the different viewers of the copies of the Web page;
computing from the data received from the different viewers a crowd-sourced F-pattern for the Web page;
subsequent to serving the copies of the Web page, modifying placement of components of the Web page to place more important components within the crowd-sourced F-pattern to the exclusion of other components of the Web page; and,
serving copies of the Web page as modified to subsequent requesting viewers over the computer communications network.

12. The computer program product of claim 11, wherein, multiple different crowd-sourced F-patterns are computed each for corresponding ones of the different viewers with a common viewing profile and the Web page is modified differently for each different crowd-sourced F-pattern and copies of each different modified Web page modified by a corresponding one of the different crowd-sourced F-patterns are served to corresponding viewers with a viewing profile common to the corresponding one of the different crowd-sourced F-patterns.

13. The computer program product of claim 11, wherein, multiple different crowd-sourced F-patterns are computed each for corresponding ones of the different viewers with common device display dimensions and the Web page is modified differently for each different crowd-sourced F-pattern and copies of each different modified Web page modified by a corresponding one of the different crowd-sourced F-patterns are served to corresponding viewers with device display dimensions common to the corresponding one of the different crowd-sourced F-patterns.

14. The computer program product of claim 11, wherein, multiple different crowd-sourced F-patterns are computed each for corresponding ones of the different viewers of a common social network and the Web page is modified differently for each different crowd-sourced F-pattern and copies of each different modified Web page modified by a corresponding one of the different crowd-sourced F-patterns are served to corresponding viewers of a social network common to the corresponding one of the different crowd-sourced F-patterns.

15. The computer program product of claim 11, wherein the components are rated in terms of importance and more highly rated ones of the components are placed in the crowd-sourced F-pattern of the modified Web page.
